(19) United States
(12) Patent Application Publication
(10) Pub. No.: US 2026/0321698 A1
(43) Pub. Date: Oct. 15, 2026

(54) SOLID OXIDE ELECTROCHEMICAL CELL INCLUDING CHROMIUM TOLERANT CURRENT COLLECTOR LAYER AND METHOD OF MAKING THE SAME

(71) Applicant: BLOOM ENERGY CORPORATION, San Jose, CA (US)

(72) Inventors: Dalton COX, Oakland, CA (US); Emad EL BATAWI, Aurora, CO (US); Travis A. SCHMAUSS, Burlingame, CA (US); Justin G. RAILSBACK, Mountain View, CA (US)

(21) Appl. No.: 19/639,960

(22) Filed: Apr. 6, 2026

Related U.S. Application Data
(60) Provisional application No. 63/785,903, filed on Apr. 9, 2025.

(51) Int. Cl. H01M 8/1253; C25B 1/04; C25B 9/73; C25B 11/091; C25B 13/07; H01M 4/90; H01M 8/12; H01M 8/241

(52) U.S. Cl. CPC H01M 8/1253; C25B 1/04; C25B 9/73; C25B 11/091; C25B 13/07; H01M 4/9033; H01M 8/241; H01M 2008/1293

(57) ABSTRACT

A solid oxide electrochemical cell includes a solid oxide electrolyte, a fuel electrode located over a fuel side of the solid oxide electrolyte, and an air electrode located over an air side of the solid oxide electrolyte. The air electrode includes an air electrode contact layer and an air electrode functional layer located between the solid oxide electrolyte and the air electrode contact layer. The air electrode contact layer includes a (La_{1-w}Ca_{w})₁₋ₓ(Ni_{y}Co_{z}Fe_{1-y-z})O₃ phase, where w ranges from 0.1 to 0.4, x ranges from 0.02 to 0.1, y ranges from 0.2 to 0.4, and z ranges from 0 to 0.2, and a chromium getter material phase.

### FIELD

The embodiments of the present disclosure are generally directed to solid oxide electrochemical cells and more specifically to solid oxide electrochemical cells including a chromium-tolerant current collector layer, and methods of making thereof.

### BACKGROUND

Electrochemical cells include solid oxide fuel cells (SOFCs) and solid oxide electrolyzer cells (SOECs). Electrochemical cell systems may include one or more stacks including electrochemical cells separated by interconnects.

### SUMMARY

According to various embodiments, a solid oxide electrochemical cell includes a solid oxide electrolyte, a fuel electrode located over a fuel side of the solid oxide electrolyte, and an air electrode located over an air side of the solid oxide electrolyte. The air electrode includes an air electrode contact layer and an air electrode functional layer located between the solid oxide electrolyte and the air electrode contact layer. The air electrode contact layer includes a (La_{1-w}Ca_{w})₁₋ₓ(Ni_{y}Co_{z}Fe_{1-y-z})O₃ phase, where w ranges from 0.1 to 0.4, x ranges from 0.02 to 0.1, y ranges from 0.2 to 0.4, and z ranges from 0 to 0.2, and a chromium getter material phase.

According to various embodiments, a method of forming a solid oxide electrochemical cell comprises providing a solid oxide electrolyte, depositing a fuel electrode over a fuel side of the solid oxide electrolyte; depositing an air electrode functional layer over an air side of the solid oxide electrolyte; depositing an air electrode contact layer over the air side functional layer to form the cell; and sintering the cell. The air electrode contact layer comprises a (La_{1-w}Ca_{w})₁₋ₓ(Ni_{y}Co_{z}Fe_{1-y-z})O₃ (“LCNCF”) phase, where w ranges from 0.1 to 0.4, x ranges from 0.02 to 0.1, y ranges from 0.2 to 0.4, and z ranges from 0 to 0.2, and a chromium getter material (“CGM”) phase.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1A is a perspective view of an electrochemical cell column, FIG. 1B is a perspective view of one solid oxide electrochemical cell stack included in the column of FIG. 1A, and FIG. 1C is a side cross-sectional view of a portion of the stack of FIG. 1B.

FIG. 2A is a top view of the air side of an interconnect of the stack of FIG. 1B, and FIG. 2B is a top view of the fuel side of the interconnect illustrated in FIG. 2A.

FIG. 3A is a perspective view of a cross-flow solid oxide electrochemical cell stack or column, FIG. 3B is an exploded perspective view of a portion of the stack of FIG. 3A, FIG. 3C is a top view of the fuel side of an interconnect included in the stack of FIG. 3A, and FIG. 3D is a schematic view of an electrochemical cell included in the stack of FIG. 3A.

FIG. 4A is a cross-sectional view of an anode supported electrochemical cell, FIG. 4B is a cross-sectional view of a co-supported electrochemical cell, and FIG. 4C is a cross-sectional view of an electrolyte supported electrochemical cell, according to various embodiments of the present disclosure.

### DETAILED DESCRIPTION

As set forth herein, various aspects of the disclosure are described with reference to the exemplary embodiments and/or the accompanying drawings in which exemplary embodiments of the invention are illustrated. This invention may, however, be embodied in many different forms and should not be construed as limited to the exemplary embodiments shown in the drawings or described herein. It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, the range may include endpoints of the range. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

Electrochemical cell systems include fuel cell and electrolyzer cell systems. In a high temperature fuel cell system, such as a solid oxide fuel cell (SOFC) system, an oxidizing flow is directed to the cathode side of the fuel cell while a fuel (e.g., hydrogen, ammonia or hydrocarbon fuel) flow is directed to the anode side of the fuel cell. The oxidizing flow is typically air, while the fuel flow can be hydrogen (H₂) or a hydrocarbon fuel, such as methane, natural gas, ethanol, or methanol, or a hydrogen containing fuel such as ammonia. The fuel cell, operating at a typical temperature between 750° C. and 950° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between the anode and the cathode, resulting in an electrical current flow through the circuit.

In an electrolyzer system, such as a solid oxide electrolyzer system (SOEC), a fuel flow comprising water (e.g., steam) is separated into hydrogen and oxygen by applying a voltage across the electrolyzer cells. In the SOEC stack, the anode is the air electrode and the cathode is the fuel electrode. Thus, the electrode to which the fuel (e.g., hydrogen, ammonia or hydrocarbon fuel in a SOFC, and steam in a SOEC) is supplied may be referred to as the fuel electrode and the opposing electrode may be referred to as the air electrode in both SOFC and SOEC cells.

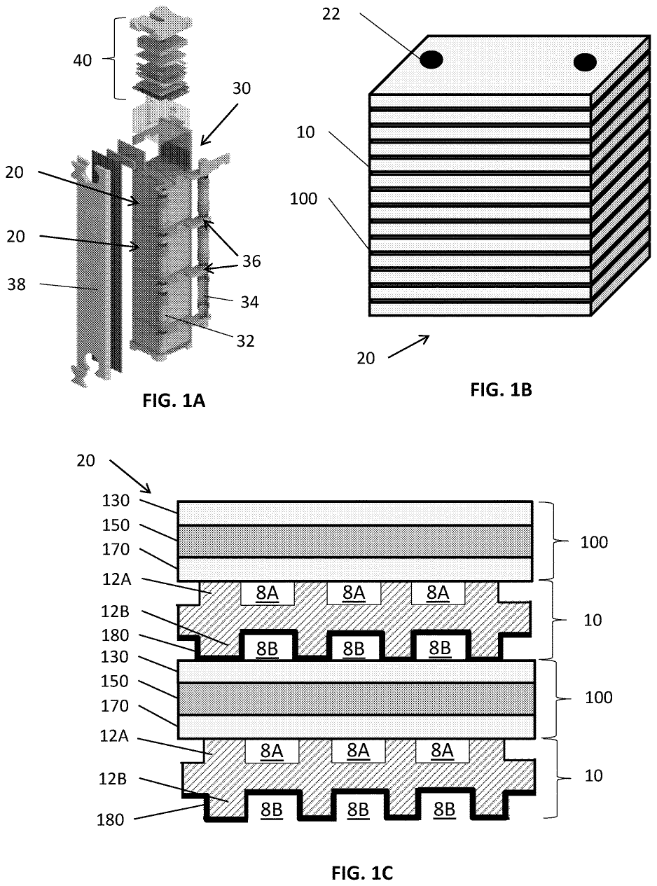

FIG. 1A is a perspective view of an electrochemical cell column 30, FIG. 1B is a perspective view of one solid oxide electrochemical cell (e.g., SOFC or SOEC) stack 20 included in the column 30 of FIG. 1A, and FIG. 1C is a side cross-sectional view of a portion of the stack 20 of FIG. 1B.

Referring to FIGS. 1A and 1B, the column 30 may include one or more electrochemical cell stacks 20, a fuel inlet conduit 32, a fuel exhaust conduit 34, and fuel feed/return assemblies 36 (e.g., anode splitter plates (ASPs) 36). The column 30 may also include side baffles 38 and a compression assembly 40. The fuel inlet conduit 32 is fluidly connected to ASPs 36 and is configured to provide the fuel feed to each ASP 36, and fuel exhaust conduit 34 is fluidly connected to ASPs 36 and is configured to receive fuel exhaust from each ASP 36.

The ASPs 36 can be disposed between the stacks 20 and above the upper-most stack 20 and are configured to provide a fuel (e.g., hydrogen, ammonia or hydrocarbon fuel or steam) feed to the stacks 20 and to receive fuel exhaust from the SOFC stacks 20 or a hydrogen product stream from the SOEC stacks 20. For example, the ASPs 36 may be fluidly connected to internal fuel holes 22 formed in the stacks 20, as discussed below.

Referring to FIG. 1C, the stack 20 includes multiple electrochemical cells 100 that are separated by interconnects 10, which may also be referred to as gas flow separator plates or bipolar plates. Each electrochemical cell 100 includes an air electrode 130, a solid oxide electrolyte 150, and a fuel electrode 170.

Each interconnect 10 electrically connects adjacent electrochemical cells 100 in the stack 20. In particular, an interconnect 10 may electrically connect the fuel electrode 170 of one electrochemical cell 100 to the air electrode 130 of an adjacent electrochemical cell 100. FIG. 1C shows that the lower electrochemical cell 100 is located between two interconnects 10.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may each include a metallic substrate comprising a high-temperature stable metal alloy, such as a chromium-iron alloy, such as 4-6 weight percent (“wt %”) iron, optionally 1 or less weight percent yttrium, and a balance of chromium. Alternatively, any other suitable conductive interconnect material, such as stainless steel (e.g., ferritic stainless steel, SS446, SS430, etc.) or iron-chromium alloy (e.g., Crofer® 22 APU alloy which contains 20 to 24 wt % Cr, less than 1 wt % Mn, Ti and La, and balance Fe, or ZMG® 232L alloy which contains 21 to 23 wt % Cr, 1 wt % Mn and less than 1 wt % Si, C, Ni, Al, Zr and La, and balance Fe).

Each interconnect 10 includes fuel ribs 12A that at least partially define fuel channels 8A and air ribs 12B that at least partially define the air channels 8B. The interconnect 10 may operate as a gas-fuel separator that separates a fuel flowing to the fuel electrode 170 of one cell in the stack from oxidant, such as air, flowing to the air electrode 130 of an adjacent cell in the stack. At either end of the stack 20, there may be an air end plate or fuel end plate (not shown) for providing air or fuel, respectively, to the end electrode in the stack. Alternatively, the same interconnect 10 may be used as an air end plate or fuel end plate.

An electrically conductive contact layer, such as a nickel layer or mesh, may be provided between anode electrodes 170 and a fuel side of each interconnect 10. An optional protective layer 180 may be provided on at least an air side of each interconnect 10. The protective layer 180 may be configured to decrease the growth rate of a chromium oxide surface layer on the interconnect 10 and to suppress evaporation of chromium vapor species which can poison the electrochemical cell air electrode. Typically, the protective layer 180 may comprise a perovskite such as lanthanum strontium manganite (LSM) and may be formed using a spray coating or dip coating process. Alternatively, other metal oxide coatings such as a spinel material, such as an (Mn, Co)₃O₄ (MCO), can be used instead of or in addition to LSM. Any spinel having the composition Mn₂₋ₓCo₁₊ₓO₄ (0≤x≤1) or written as z(Mn₃O₄)+(1−z) (Co₃O₄), where (1/3≤z≤2/3) or written as (Mn, Co)₃O₄ may be used. In other embodiments, a mixed layer of LSM and MCO, or a combination of LSM and MCO layers may be used as the protective layer 180.

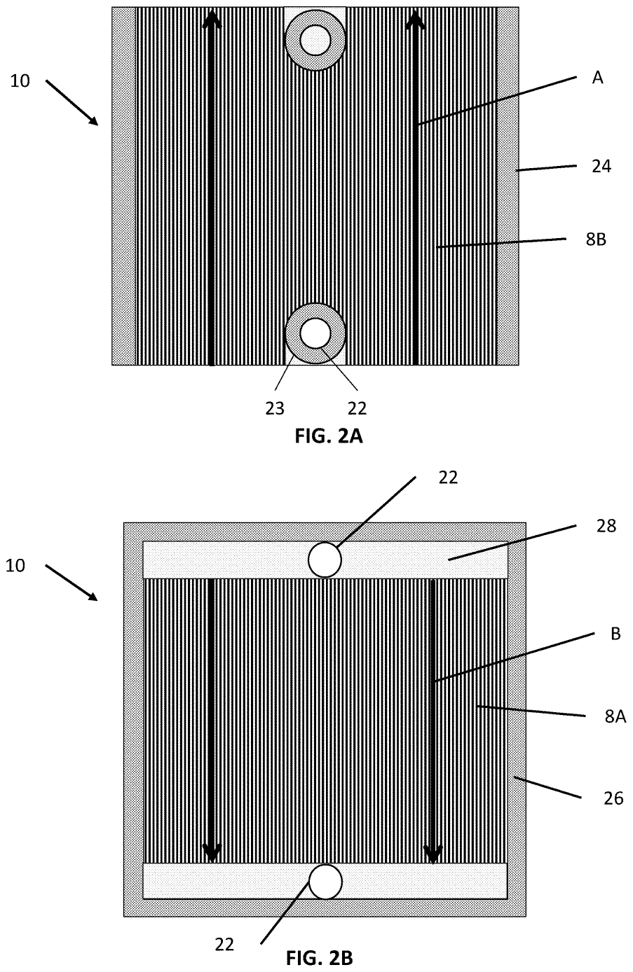

FIG. 2A is a top view of the air side of a counter-flow (or co-flow) interconnect 10, and FIG. 2B is a top view of a fuel side of the interconnect 10. Referring to FIGS. 1C and 2A, the air side includes the air channels 8B. Air flows through the air channels 8B to an air electrode 130 of an adjacent electrochemical cell 100. In particular, the air may flow across the interconnect 10 in a first direction A as indicated by the arrows.

Ring seals 23 may surround the fuel holes 22 of the interconnect 10, to prevent a fuel, such as a fuel or steam, from contacting the air electrode 130. Peripheral strip-shaped seals 24 are located on peripheral portions of the air side of the interconnect 10. The seals 23, 24 may be formed of a glass material. The peripheral portions may be in the form of an elevated plateau which does not include ribs or channels. The surface of the peripheral regions may be coplanar with tops of the air ribs 12B.

Referring to FIGS. 1C and 2B, the fuel side of the interconnect 10 may include the fuel channels 8A and fuel manifolds 28 (e.g., fuel plenums). A fuel such as a fuel or steam flows from one of the fuel holes 22, into the adjacent manifold 28, through the fuel channels 8A, and to a fuel electrode 170 of an adjacent electrochemical cell 100. Excess fuel may flow into the other fuel manifold 28 and then into the adjacent fuel hole 22. In particular, the fuel may flow across the interconnect 10 in a second direction B, as indicated by the arrows. The second direction B may be opposite to the first direction A (see FIG. 2A) referred to as a counter-flow design, or in the same direction as first direction A referred to as co-flow design.

A frame-shaped seal 26 is disposed on a peripheral region of the fuel side of the interconnect 10. The peripheral region may be an elevated plateau which does not include ribs or channels. The surface of the peripheral region may be coplanar with tops of the fuel ribs 12A.

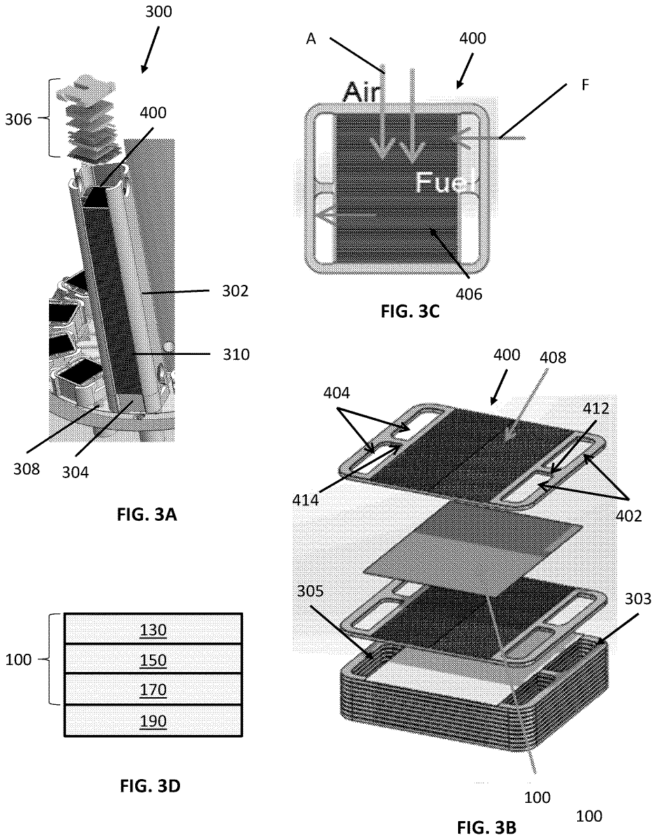

FIG. 3A is a perspective view of an internally manifolded cross-flow electrochemical cell column 300, according to various embodiments of the present disclosure, FIG. 3B is an exploded perspective view of a portion of the column 300 of FIG. 3A, FIG. 3C is a top view of the fuel side of an interconnect 400 included in the column 300, and FIG. 3D is a schematic view of an electrochemical cell included in the column 300.

Referring to FIGS. 3A-3D, the cell column 300, which may also be referred to as an electrochemical cell stack because it lacks ASPs, includes multiple electrochemical cells 100 (e.g., fuel cells or electrolyzer cells) that are separated by interconnects 400, which may also be referred to as gas flow separator plates or bipolar plates. One or more columns 300 may be thermally integrated with other components of an electrochemical cell system (e.g., one or more anode tail gas oxidizers, fuel reformers, fluid conduits and manifolds, etc. of a SOFC or SOEC system) in a common enclosure or “hotbox.”

Each electrochemical cell 100 may include a solid oxide electrolyte 150, a fuel electrode 170, and an air electrode 130. In some embodiments, the fuel electrode 170 and the air electrode 130 may be printed on the electrolyte 150. In other embodiments, a conductive layer 190, such as a nickel mesh, may be disposed between the fuel electrode 170 and an adjacent interconnect 400. The electrochemical cell 100 does not include through holes, such as the fuel holes described above.

The interconnects 400 are made from an electrically conductive metal alloy. An upper most interconnect 400 and a lowermost interconnect 400 of the column 300 may be different ones of an air end plate or fuel end plate including features for providing air or fuel, respectively, to an adjacent end electrochemical cell 100 in the stack 300. As used herein, an “interconnect” may refer to either an interconnect located between two electrochemical cells 100 or an end plate located at an end of the stack and directly adjacent to only one electrochemical cell 100. Since the column 300 does not include ASPs and the end plates associated therewith, the column 300 may include only two end plates.

The column 300 may include side baffles 302, a fuel plenum 304, and a compression assembly 306. The side baffles 302 may be formed of a ceramic material and may be disposed on opposing sides of the cell column 300 containing stacked electrochemical cells 100 and interconnects 400. The side baffles 302 may connect the fuel plenum 304 and the compression assembly 306, such that the compression assembly 306 may apply pressure to the column 300. The side baffles 302 may be curved baffle plates, such that each baffle plate covers at least portions of three sides of the cell column 300. For example, one baffle plate may fully cover the fuel inlet riser side of the column 300 and partially cover the adjacent front and back sides of the stack, while the other baffle plate fully may cover the fuel outlet riser side of the stack and partially cover the adjacent portions of the front and back sides of the stack. The remaining uncovered portions for the front and back sides of the stack allow air to flow through the column 300. The fuel plenum 304 may be disposed below the column 300 and may be configured to provide a hydrogen-containing fuel feed to the column 300 and may receive a fuel exhaust from the column 300. The fuel plenum 304 may be connected to fuel inlet and outlet conduits 308 which are located below the fuel plenum 304.

Each interconnect 400 electrically connects adjacent electrochemical cells 100 in the column 300. In particular, an interconnect 400 may electrically connect the fuel electrode 170 of one electrochemical cell 100 to the air electrode 130 of an adjacent electrochemical cell 100. As shown in FIG. 3C, each interconnect 400 may be configured to channel air in a first direction A, such that the air may be provided to the air electrode 130 of an adjacent electrochemical cell 100. Each interconnect 400 may also be configured to channel fuel in a second direction F, such that the fuel may be provided to the fuel electrode 170 of an adjacent electrochemical cell 100. Directions A and F may be perpendicular, or substantially perpendicular. As such, the interconnects 400 may be referred to as cross-flow interconnects.

The interconnect 400 may include through-holes configured for fuel distribution. For example, the interconnects 400 may include one or more fuel inlets 402 and one or more fuel outlets 404, which may also be referred to as fuel exhaust outlets 404. The fuel inlets and outlets 402, 404 may be disposed outside of the perimeter of the electrochemical cells 100. As such, the electrochemical cells 100 may be formed without corresponding through holes for fuel flow. The combined length of the fuel inlets 402 and/or the combined length of the fuel outlets 404 may be at least 75% of a corresponding length of the interconnect 400, e.g., a length taken in direction A.

In one embodiment, each interconnect 400 contains two fuel inlets 402 separated by a neck portion 412 of the interconnect 400, as shown in FIG. 3B. However, more than two fuel inlets 402 may be included, such as three to five inlets separated by two to four neck portions. In one embodiment, each interconnect 400 contains two fuel outlets 404 separated by a neck portion 414 of the interconnect 400, as shown in FIG. 3B. However, more than two fuel outlets 404 may be included, such as three to five outlets separated by two to four neck portions 414. Although not illustrated, the number of fuel inlets and fuel outlets can be different. The fuel inlets 402 and outlets 404 may be fluidly connected by fuel channels 406 that extend on the fuel side of the interconnect 400. Air channels 408 may be disposed on an opposing air side of the interconnect 400.

The fuel inlets 402 of adjacent interconnects 400 may be aligned in the column 300 to form one or more fuel inlet risers 303. The fuel outlets 404 of adjacent interconnects 400 may be aligned in the column 300 to form one or more fuel outlet risers 305. The fuel inlet riser 303 may be configured to distribute fuel received from the fuel plenum 304 to the electrochemical cells 100. The fuel outlet riser 305 may be configured to provide fuel exhaust received from the electrochemical cells 100 to the fuel plenum 304.

The side baffles 302 may optionally be curved around edges of the interconnects 400. In particular, the side baffles 302 may be disposed around the fuel inlets 402 and outlets 404 of the interconnects 400. Accordingly, the side baffles may more efficiently control air flow through air channels of the interconnects 400, which are exposed between the side baffles 302. In various embodiments, the column 300 may include from 200 to 400 electrochemical cells, such as 250 to 350 electrochemical cells, more particularly from 275 to 325 electrochemical cells, which may be provided with fuel using only the fuel risers 303.

Each interconnect 400 may be made of or may contain electrically conductive material, such as a metal alloy which has a similar coefficient of thermal expansion to that of the solid oxide electrolyte in the cells (e.g., a difference of 0-10%). The interconnects 400 may electrically connect the fuel electrode 170 of one electrochemical cell 100 to the air electrode 130 of an adjacent electrochemical cell 100. An electrically conductive contact layer, such as a nickel contact layer 190 (e.g., a nickel mesh), may be provided between fuel electrode 170 and each interconnect 400.

Electrochemical cells, such as SOFCs and SOECs, are typically supported in order to increase mechanical stability and reliability. For example, solid oxide electrochemical cells include electrode-supported cells, electrolyte-supported cells, and co-supported cells. Electrolyte-supported cells include a relatively thick electrolyte upon which relatively thin electrodes are formed. Electrode supported cells include a relatively thick supporting electrode (e.g., fuel electrode, such as the anode for SOFC) to provide structural support, and co-supported cells may include a relatively thick supporting electrode and a relatively thick electrolyte.

Electrode-supported SOFCs and SOECs are typically produced by co-sintering a support electrode material and a coating of electrolyte material. Electrode-supported cells include anode-supported cells having a relatively thick anode and cathode-supported cells having a relatively thick cathode. As used herein, anode-supported cells refer to fuel-electrode supported SOFCs and SOECs (even though the fuel electrode functions as a cathode electrode in a SOEC) due to common naming convention in the art.

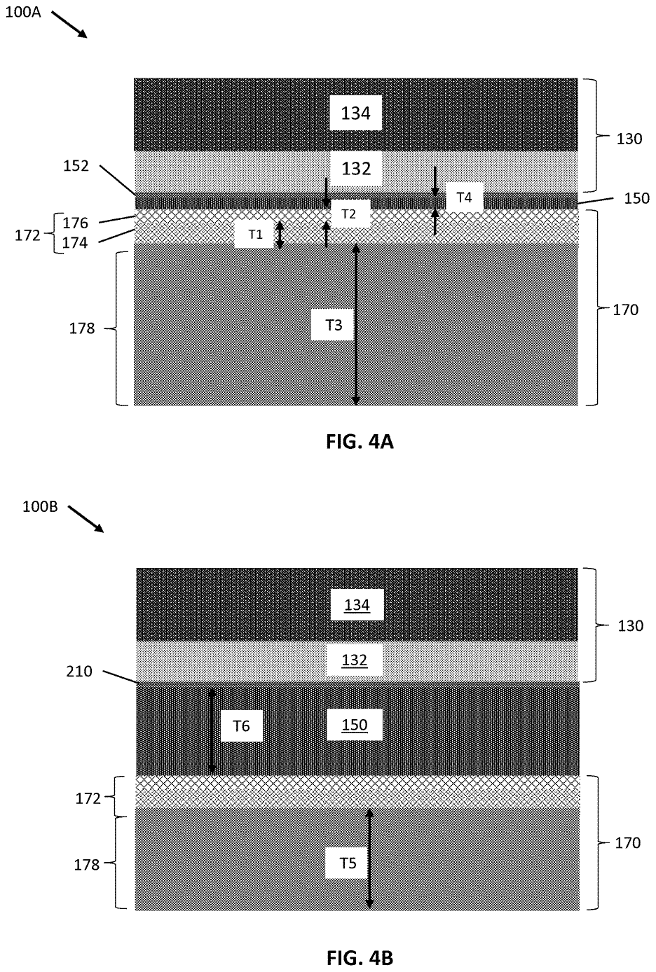

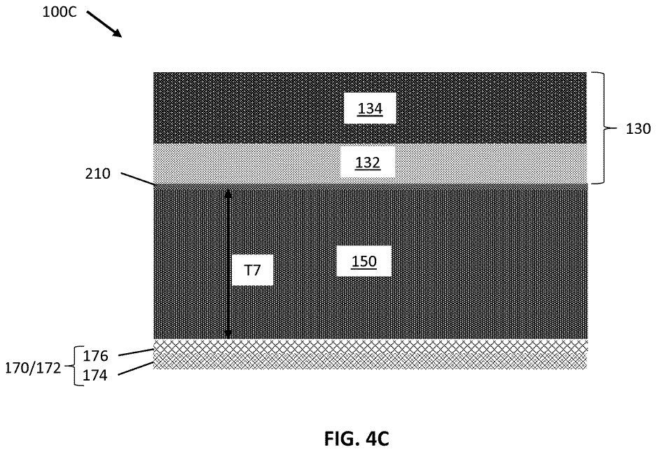

FIG. 4A is a cross-sectional view of an anode supported electrochemical cell 100A, FIG. 4B is a cross-sectional view of a co-supported electrochemical cell 100B, and FIG. 4C is a cross-sectional view of an electrolyte supported electrochemical cell 100C, according to various embodiments of the present disclosure.

Referring to FIGS. 4A-4C, the electrochemical cells 100A, 100B, 100C may comprise SOFCs which include an electrolyte 150, an anode (i.e., fuel electrode) 170 disposed on a first side (e.g., anode or fuel side) of the electrolyte 150, and a cathode electrode (i.e., air electrode) 130 disposed on a second side (e.g., cathode or air side) of the electrolyte 150. In SOECs, the fuel electrode 170 is the cathode and the air electrode 130 is the anode. The electrolyte 150 may be formed of an ionically conductive ceramic material, such as a doped zirconia material or a doped ceria material. For example, the electrolyte 150 may include scandia stabilized zirconia (SSZ), yttria stabilized zirconia (YSZ), yttria-ceria-stabilized zirconia (YCSZ), ytterbia-ceria-scandia-stabilized zirconia (YbCSSZ), or blends thereof.

Preferably, the electrolyte 150 may include YbCSSZ, wherein scandia may be present in an amount equal to 9 to 11 mol %, such as 10 mol %, ceria may present in amount greater than 0 and equal to or less than 3 mol %, for example 0.5 mol % to 2.5 mol %, such as 1 mol %, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference.

The electrolyte 150 may optionally include a barrier layer 152 disposed on the cathode side. The barrier layer 152 may be configured to prevent diffusion of cathode materials into the electrolyte 150. The barrier layer 152 may comprise yttria stabilized zirconia, scandia and yttria stabilized zirconia or samaria doped ceria.

The SOFC cathode electrode 130 may be disposed on the barrier layer 152. The cathode electrode 130 may be a single or multi-layer structure. For example, the cathode electrode 130 may include a cathode functional layer 132 and a cathode current collector layer (CCL) 134. The cathode functional layer 132 may include a cathode catalyst, such as lanthanum strontium manganate, lanthanum strontium cobaltite, lanthanum strontium cobalt ferrite or lanthanum nickel ferrite. The cathode functional layer 132 may also optionally include an additional ceramic phase, such as a doped ceria phase, for example a samaria doped ceria or a gadolinia doped ceria. The CCL 134 may include an electrically conductive material, as will be described below, configured to reduce electrical resistance between the cathode electrode 130 and an adjacent component, such as an interconnect. It should be noted that for a SOEC, the air side electrode 130 comprises the anode rather than the cathode. Thus, the term “CCL” refers to the air electrode contact layer for both SOECs and SOFCs, and the term “cathode functional layer” refers to the air electrode functional layer SOECs and SOFCs.

The SOFC anode 170 may include an anode electrode 172 disposed on the anode side of the electrolyte 150 and an anode support 178 disposed on the anode electrode 172. The anode electrode 172 may include a nickel containing phase and an ionically conductive ceramic phase, such as SSZ, YSZ, YbCSSZ, or a doped ceria such as gadolinia, yttria and/or samaria doped ceria (SDC). Preferably, the anode electrode 172 comprises a Ni-SDC cermet or a Ni-YbCSSZ cermet. In some embodiments, the Ni phase may include an optional additional metal dopant to improve phase stability and/or redox tolerance.

The anode electrode 172 may be a single or multi-layer structure. For example, the anode electrode 172 may include a first functionally graded anode (FGA) layer 174 and a second FGA layer 176. The first FGA layer 174 may include a higher ratio of the nickel containing phase to the ionically conductive phase than the second FGA layer 176.

The first FGA layer 174 may have a thickness T1 ranging from about 7 μm to about 17 μm, such as from about 10 μm to about 14 μm, or from about 11 μm to about 13 μm. The second FGA layer 176 may have a thickness T2 ranging from about 2 μm to about 10 μm, such as from about 4 μm to about 8 μm, or from about 5 μm to about 6 μm. However, the present disclosure is not limited to any particular FGA layer thicknesses.

The anode support 178 may be formed of a cermet material having a metal phase and a ceramic phase. For example, the anode support 178 may include a nickel-containing phase (e.g., nickel phase) and a ceramic phase. The nickel phase may include nickel and/or nickel alloys and may optionally include other additional metal dopants to improve phase stability and/or redox tolerance, as discussed in detail below.

The ceramic phase may comprise a stabilized zirconia, yttria stabilized zirconia (YSZ), scandia stabilized zirconia (SSZ), yttria-scandia stabilized zirconia (YSSZ), and/or a doped ceria material, such as gadolinia, yttria and/or samaria doped ceria. The ceramic phase may be optionally doped with additional phase stabilizers, as discussed in detail below. Preferably, the ceramic phase of the anode support 178 comprises YSZ comprising from about 4 mol % to about 10 mol % yttria (4-10)-YSZ. The ceramic phase (e.g., the (4-10)-YSZ) may include additional dopants (e.g., phase stabilizers) to improve phase stability.

As shown in FIG. 4A, in the anode supported electrochemical cell 100A, the anode support 178 may have a thickness T3 ranging from about 200 μm to about 400 μm, such as from about 250 μm to about 350 μm, or from about 275 μm to about 325 μm. The electrolyte 150 may have a thickness T4 ranging from about 4 μm to about 20 μm, such as from about 5 μm to about 15 μm, or from about 8 μm to about 13 μm. Accordingly, the relatively thick anode support 178 may support the relatively thin electrolyte 150.

As shown in FIG. 4B, the co-supported electrochemical cell 100B may include a relatively thin anode support 178 and a relatively thick electrolyte 150. In particular, the anode support 178 may have a thickness T5 ranging from about 50 μm to about 100 μm, such as from about 60 μm to about 90 μm, or from about 70 μm to about 80 μm. The electrolyte 150 may have a thickness T6 ranging from about 20 μm to about 50 μm, such as from about 25 μm to about 45 μm, from about 30 μm to about 40 μm. The relatively thick electrolyte 150 may be self-supporting. As such, the thickness of the anode support 178 may be reduced, as compared to the anode support 178 of the cell 100B, without compromising cell strength.

As shown in FIG. 4C, the electrolyte 150 may be the thickest layer of the electrolyte supported cell 100C. For example, the electrolyte 150 may have a thickness T7 ranging from about 50 μm to about 400 μm, such as from about 75 μm to about 300 μm, or from about 100 μm to about 150 μm. The anode 170 may not include a support 178, such that the anode electrode 172 may be unsupported.

Referring to FIGS. 4A-4C, the coefficient of thermal expansion (CTE) of each cell 100A-100C may be determined primarily by the CTE of the thickest layer thereof. In other words, other thinner layers of the cell 100A-100C may not significantly contribute to the overall CTE of the cell 100A-100C. For example, the CTE of anode supported cell 100A may be determined by the CTE of the anode 170 (e.g., the anode support 178), the CTE of the co-supported cell 100B may be determined by the CTE of the electrolyte 150 and the CTE of the anode 170, and the CTE of the electrolyte supported cell 100C may be determined by the CTE of the electrolyte 150.

### Chromium-Tolerant Air Electrode Current Collector Layer

Solid oxide electrochemical stacks may operate at relatively high temperatures of 650° C. of more. High operating temperatures may result in the release of contaminants, such as chromium (Cr) species. Specifically, due to the high operating temperatures of the solid oxide electrochemical stacks, Cr species may evaporate from Cr-containing balance-of-plant components (e.g., Cr-containing alloy heat exchangers and various conduits) and Cr-containing interconnect materials into an air inlet stream that is provided to the stacks. Cr species are volatile compounds that attack conventional CCL 134 materials, such as (La,Sr)MnO₃ (LSM), (La,Sr)CoO₃ (LSC), or (La,Sr)(Co,Fe)O₃ (LSCF), which lead to air electrode 130 poisoning and associated reduction in electric conductivity.

In particular, Sr and Mn bond readily with Cr species to form electrically insulating mixed oxides, such as SrCrO₄ and (Mn,Cr)₃O₄, respectively. With regard to LSM, either of the Sr and Mn sites may be attacked by Cr species, which causes the conductive LSM structure to breakdown and become insulating. For LSC and LSCF, the Sr to Cr bonding activity is increased due to the Co ions in the B-site of the perovskite structure, which also leads to a breakdown in crystal structure and decreased electric conductivity.

According to various embodiments, CCL (i.e., the air electrode contact layer) 134 materials may include a current collecting material (CCM) and a Cr gettering material (CGM) to reduce Cr poisoning of the air electrode (e.g., SOFC cathode or SOEC anode) 130. The CCM may exclude Sr and/or Mn, which operate as primary Cr poisoning sites. Removing Sr decreases electric conductivity, but calcium (Ca) is used as a substitute. While Ca is less effective than Sr at increasing La-based perovskite conductivity, it has a lower Cr affinity by nature of its lower basicity. Ca substitution also decreases the La activity, therefore decreasing its driving force to bond to Cr. La and Ca still bond with Cr. By making the material A-site deficient, the La and Ca driving force to bond with Cr decreases.

In various embodiments, the CCM may be an A-side deficient, calcium-containing perovskite material having dual-doped or tri-doped B-sites. For example, the CCM may be represented by the formula (La_{1-w}Ca_{w})₁₋ₓ(Ni_{y}Co_{z}Fe_{1-y-z})O₃ (“LCNCF”) where w ranges from 0.1 to 0.4, x ranges from 0.02 to 0.1, y ranges from 0.2 to 0.4, and z ranges from 0 to 0.2, such as from 0.05 to 0.2 when the CCM is a tri-doped B-site material that includes cobalt in addition to nickel and iron on the B-site of the perovskite crystal lattice. Alternatively, z may equal to zero if the CCM is a dual-doped B-site material that excludes cobalt. In some embodiments, w ranges from 0.2 to 0.3, x ranges from 0.04 to 0.09, y ranges from 0.25 to 0.35, and z ranges from 0.1 to 0.2. LCNCF may have a low driving force for Cr poisoning as compared to LSM, LSC, and/or LSCF.

The CGM may comprise an electrically conductive material, such as the MCO spinel described above, or an electrically insulating material, such as SrMnO₃ (SMO). MCO has appreciable intrinsic electronic conductivity (~40 S/cm) and upon reaction with Cr maintains at least some of that conductivity. SMO has little electronic conductivity before or after reaction with Cr, but it is more reactive with volatile Cr species.

In some embodiments, the CCL 134 may have an LCNCF:MCO weight ratio ranging from 0.5:2 to 2:0.5, such as from 1:2 to 2:1, including 1.5:2 to 2:1.5. In other embodiments, the CCL 134 may have an LCNCF:SMO weight ratio ranging from 2.5:1 to 4.5:1, such as from 3:1 to 4:1.

In various embodiments, a solid oxide electrochemical cell, such as the anode supported electrochemical cell 100A shown in FIG. 4A may be formed by depositing the first FGA layer 174 on the anode support 178, depositing the second FGA layer 176 on the first FGA layer 174, and then depositing the electrolyte 150 on the second FGA layer 176. The resulting structure may be sintered at a relatively high temperature. For example, the sintering temperature may range from 1250° C. to 1450° C., such as from 1300° C. to 1400° C.

The cathode (i.e., the air electrode) 130 may be formed on the sintered structure. For example, a cathode functional layer (i.e., air electrode functional layer) 132 may be formed by printing or coating an ink on the electrolyte 150. The ink may include electrically conductive perovskite particles (e.g., LSM, LSC or LSCF particles) and ionically conductive particles (e.g., SDC or GDC particles) in the liquid phase of the ink.

For the electrolyte supported cell 100C, the anode 170 and the cathode 130 may be printed on opposite sides of the electrolyte 150. For example, the anode 170 may be printed on the fuel side of the electrolyte 150 followed by sintering. The cathode 130 may then be printed on the air side of the electrolyte 150 followed by an additional sintering step.

In one embodiment, the CCL 134 may be formed by printing or coating a CCL ink on the cathode functional layer 132. The CCL ink may include a mixture of the above described LCNCF particles and at least one of the MCO or SMO particles in the liquid phase of the CCL ink. The resultant structure may be sintered at a relatively low temperature to form a solid oxide electrochemical cell 100A. For example, the sintering temperature may range from 1000° C. to 1200° C., such as from 1050° C. to 1150° C.

The CCL ink may include the above described CCM particles, the above described CGM particles, a liquid phase, and an optional dispersant. For example, the CCL ink may include the LCNCF particles and at least one of MCO particles and/or SMO particles suspended in the liquid phase. The liquid phase may be a polar solvent, such as water, or a nonpolar solvent, such as alcohol. After sintering, the CCL 134 may include distinct CCM and CGM phases which may be uniformly dispersed in the CCL 134. In other words, the CCL 134 may include separate LCNCF phase and a separate MCO or SMO phase.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. A solid oxide electrochemical cell, comprising:
a solid oxide electrolyte;
a fuel electrode located over a fuel side of the solid oxide electrolyte; and
an air electrode located over an air side of the solid oxide electrolyte,
wherein:
the air electrode comprises an air electrode contact layer and an air electrode functional layer located between the solid oxide electrolyte and the air electrode contact layer; and
the air electrode contact layer comprises a (La_{1-w}Ca_{w})₁₋ₓ(Ni_{y}Co_{z}Fe_{1-y-z})O₃ (“LCNCF”) phase, where w ranges from 0.1 to 0.4, x ranges from 0.02 to 0.1, y ranges from 0.2 to 0.4, and z ranges from 0 to 0.2, and a chromium getter material (“CGM”) phase.

2. The solid oxide electrochemical cell of claim 1, wherein the CGM phase comprises at least one of (Mn,Co)₃O₄ (“MCO”) or SrMnO₃ (“SMO”).

3. The solid oxide electrochemical cell of claim 2, wherein the CGM phase comprises the MCO phase, and a LCNCF:MCO weight ratio ranges from 1:2 to 2:1.

4. The solid oxide electrochemical cell of claim 2, wherein the CGM phase comprises the SMO phase, and a LCNCF:SMO weight ratio ranges from 3:1 to 4:1.

5. The solid oxide electrochemical cell of claim 1, wherein z equals zero.

6. The solid oxide electrochemical cell of claim 1, wherein w ranges from 0.2 to 0.3, x ranges from 0.04 to 0.09, y ranges from 0.25 to 0.35, and z ranges from 0.1 to 0.2.

7. The solid oxide electrochemical cell of claim 1, wherein the solid oxide electrolyte comprises scandia stabilized zirconia (SSZ), yttria stabilized zirconia (YSZ), yttria-ceria-stabilized zirconia (YCSZ), or ytterbia-ceria-scandia-stabilized zirconia (YbCSSZ).

8. The solid oxide electrochemical cell of claim 1, wherein the air electrode functional layer comprises doped ceria and at least one of lanthanum strontium manganate, lanthanum strontium cobaltite, lanthanum strontium cobalt ferrite, or lanthanum nickel ferrite.

9. The solid oxide electrochemical cell of claim 1, wherein the electrochemical cell comprises a solid oxide electrolyzer cell.

10. The solid oxide electrochemical cell of claim 1, wherein the solid oxide electrochemical cell comprises a solid oxide fuel cell in which the air electrode comprises a cathode and the fuel electrode comprises an anode.

11. The solid oxide electrochemical cell of claim 10, wherein the solid oxide fuel cell comprises an anode supported cell which further comprises an anode support comprising a nickel-containing phase and a ceramic phase.

12. The solid oxide electrochemical cell of claim 11, wherein:
the anode support has a thickness ranging from about 200 μm to about 400 μm; and
the solid oxide electrolyte layer has a thickness ranging from about 4 μm to about 20 μm.

13. The solid oxide electrochemical cell of claim 1, wherein the solid oxide electrochemical cell comprises an electrolyte supported cell, and wherein the solid oxide electrolyte is thicker than the fuel electrode, and the solid oxide electrolyte is thicker than the air electrode.

14. An electrochemical cell stack, comprising:
interconnects; and
the solid oxide electrochemical cells of claim 1 located between the interconnects.

15. A method of forming a solid oxide electrochemical cell, comprising:
providing a solid oxide electrolyte and depositing a fuel electrode over a fuel side of the solid oxide electrolyte;
depositing an air electrode functional layer over an air side of the solid oxide electrolyte;
depositing an air electrode contact layer over the air side functional layer to form the cell; and
sintering the cell,
wherein the air electrode contact layer comprises a (La_{1-w}Ca_{w})₁₋ₓ(Ni_{y}Co_{z}Fe_{1-y-z})O₃ (“LCNCF”) phase, where w ranges from 0.1 to 0.4, x ranges from 0.02 to 0.1, y ranges from 0.2 to 0.4, and z ranges from 0 to 0.2, and a chromium getter material (“CGM”) phase.

16. The method of claim 15, wherein the step of depositing the air electrode contact layer comprises depositing an ink comprising LCNCF particles and CGM particles in a liquid phase.

17. The method of claim 16, wherein the CGM phase comprises at least one of (Mn,Co)₃O₄ (“MCO”) or SrMnO₃ (“SMO”).

18. The method of claim 17, wherein the CGM phase comprises the MCO phase, and a LCNCF:MCO weight ratio ranges from 1:2 to 2:1.

19. The method of claim 17, wherein the CGM phase comprises the SMO phase, and a LCNCF:SMO weight ratio ranges from 3:1 to 4:1.

20. The method of claim 15, wherein:
w ranges from 0.2 to 0.3, x ranges from 0.04 to 0.09, y ranges from 0.25 to 0.35, and z ranges from 0.1 to 0.2;
the solid oxide electrolyte comprises scandia stabilized zirconia (SSZ), yttria stabilized zirconia (YSZ), yttria-ceria-stabilized zirconia (YCSZ), or ytterbia-ceria-scandia-stabilized zirconia (YbCSSZ);
the air electrode functional layer comprises doped ceria and at least one of lanthanum strontium manganate, lanthanum strontium cobaltite, lanthanum strontium cobalt ferrite, or lanthanum nickel ferrite; and
the electrochemical cell comprises a solid oxide electrolyzer cell or a solid oxide fuel cell.
